(19) United States
(12) Patent Application Publication
(10) Pub. No.: US 2026/0230775 A1
(43) Pub. Date: Aug. 6, 2026

(54) TECHNIQUES INCLUDING GROUPS FOR SUPPORTING POSITIONING FOR MOBILE USER EQUIPMENT IN REDUCED-POWER STATES

(71) Applicant: Apple Inc., Cupertino, CA (US)

(72) Inventors: Oghenekome OTERI, San Diego, CA (US); Dawei ZHANG, Saratoga, CA (US); Sigen YE, San Diego, CA (US); Haitong SUN, Saratoga, CA (US); Wei ZENG, Saratoga, CA (US); Chunxuan YE, San Diego, CA (US)

(21) Appl. No.: 19/156,344

(22) PCT Filed: Feb. 14, 2024
(86) PCT No.: PCT/US2024/015803

§ 371 Date: Aug. 13, 2025

Related U.S. Application Data
(60) Provisional application No. 63/484,884, filed on Feb. 14, 2023.

(51) Int. Cl. H04W 4/029; H04W 52/02; H04W 56/00; H04W 74/0833; H04W 76/27

(52) U.S. Cl. CPC H04W 4/029; H04W 52/0251; H04W 56/0045; H04W 74/0833; H04W 76/27

(57) ABSTRACT

Techniques for supporting positioning for mobile UEs in reduced-power states are described, such as for low power high accuracy positioning (LPHAP). In many embodiments, uplink (UL) and/or UL+downlink (DL) positioning for UEs in inactive and/or idle states are enabled in a manner that improves positioning services in 5G networks by reducing the need to transition into higher power states. For example, positioning configuration groups may be utilized to enable a common positioning configuration, or portions thereof, to be utilized in multiple network cells. In various embodiments, a power metric of signals may be utilized to determine network cells in a positioning configuration group. In another example, various techniques are utilized to obtain, validate, or update positioning configurations and/or activate positioning transmissions at a UE with the UE in an inactive or idle state.

### CROSS-REFERENCE TO RELATED APPLICATIONS

This application claims the benefit of and priority to U.S. Provisional Patent Application No. 63/484,884 filed Feb. 14, 2023. The entirety of which is incorporated herein by reference.

### FIELD OF INVENTION

This disclosure related generally to wireless technology and more particularly to supporting positioning for mobile user equipment in reduced-power states.

### BACKGROUND

In telecommunications, 5G is the fifth-generation technology standard for broadband cellular networks. Like its predecessors, 5G networks are cellular networks, in which the service area is divided into small geographical areas called network cells (or cells). The 3rd Generation Partnership Project (3GPP) is the industry consortium that sets standards for 5G. In 5G, a number of different features are supported, such as positioning. Positioning may refer to a process for identifying the location of a mobile user equipment (UE), whether stationary or moving. Localization can be achieved using a variety of techniques, such as by determining one or more of roundtrip time (RTT), angle of arrival (AoA), angle of departure (AoD), and time difference of arrival (TDOA) of signals. In 5G, AoA and AoD positioning techniques can be supported using multi-user Multiple Input Multiple Output (MIMO) antennas, which provide a precise orientation of the signal in one specific direction instead of a multidirectional broadcast.

### BRIEF SUMMARY

Processes, machines, and articles of manufacture for supporting positioning for mobile user equipment in reduced-power states are described. It will be appreciated that the embodiments may be combined in any number of ways without departing from the scope of this disclosure.

Embodiments may include releasing from a connected state to an inactive or idle state at a UE; determining a current positioning configuration is invalid; and obtaining, at the UE, an updated positioning configuration in the inactive or idle state.

Embodiments may include obtaining a positioning configuration in a first network cell that is included in a positioning configuration group; releasing from a connected state to an inactive or idle state in the first network cell; transitioning from the first network cell to a second network cell, wherein the second network cell is included in the positioning configuration group; and utilizing, in the inactive or idle state, at least a portion of the positioning configuration obtained in the first network cell for positioning in the second network cell based on inclusion of the first and second network cells in the positioning configuration group.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry according to some embodiments.

FIG. 6 illustrates an example block diagram of a network message according to some embodiments.

FIG. 7 illustrates various aspects of positioning in telecommunication networks according to some embodiments.

FIG. 8 illustrates a logic flow for updating positioning configurations according to some embodiments.

FIGS. 9A and 9B illustrate exemplary process diagrams for updating positioning configurations in an inactive state according to some embodiments.

FIGS. 10A and 10B illustrate exemplary process diagrams for updating positioning configurations in an idle state according to some embodiments.

FIGS. 11A-11C illustrate exemplary process diagrams for positioning activation procedures according to some embodiments.

FIG. 12 illustrates a logic flow of an exemplary technique for obtaining an updated positioning configuration according to some embodiments.

FIG. 13 illustrates a logic flow of an exemplary technique for positioning configuration groups according to some embodiments.

### DETAILED DESCRIPTION

Techniques for supporting positioning for mobile user equipment in reduced-power states are described. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etcetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

Generally, this disclosure describes techniques for supporting positioning for mobile UEs in reduced-power states. For example, techniques disclosed hereby may be utilized to enable a UE to perform low power high accuracy positioning (LPHAP). In many embodiments, the techniques may facilitate uplink (UL) and/or UL+downlink (DL) positioning for UEs in inactive and/or idle states in a manner that improves positioning services in 5G networks by reducing the need to transition into higher power states (e.g., a connected state). For example, sounding reference signal (SRS) enhancements based on SRS positioning validity area may be used to reduce the need to transition into a connected state for positioning (re) configuration. In some such examples, positioning configuration groups may be utilized to enable a common positioning configuration, or portions thereof, to be utilized in multiple network cells. In various embodiments, a power metric of signals may be utilized to determine network cells in a positioning configuration group. In another example, various techniques are utilized to obtain, validate, or update positioning configurations (e.g., positioning SRS (SRSp) configurations, timing advance (TA) configurations, path loss references, and the like) and/or activate positioning transmissions at a UE with the UE in an inactive or idle state. It will be appreciated that various aspects of telecommunication networks, capabilities, protocols, and procedures relevant to the techniques described and terms referenced herein can be found in 3GPP technical specifications (TS), such as TS 38.321, TS 38.331, TS 22.104, and TS 22.261.

The subject matter described hereby provides many technical advantages. For instance, the computer-based techniques of the current disclosure improve the functioning of a telecommunications system as compared to conventional approaches because the techniques enable robust support for LPHAP that can improve the positioning power efficiency, positioning accuracy, accessibility, and efficiency of telecommunication networks, reduce congestion, and provide expanded capabilities versus conventional approaches. For example, facilitating positioning in the inactive or idle state can enable available radio resources to support more UEs. It can also enable tracking of the UE's accurate position in states outside the connected state. In another example, UE battery life can be extended by enabling UEs to spend more time in the inactive or idle state as opposed to having to transition back to a connected state, such as for updating configuration data. In yet another example, positioning configuration validity criteria can be utilized to extend the usability of positioning configurations, such as by reducing the frequency with which new positioning configurations are required. Accordingly, embodiments disclosed hereby can be practically utilized to improve the functioning of a computer and/or to improve the technical fields of telecommunications, 5G positioning services, and/or LPHAP.

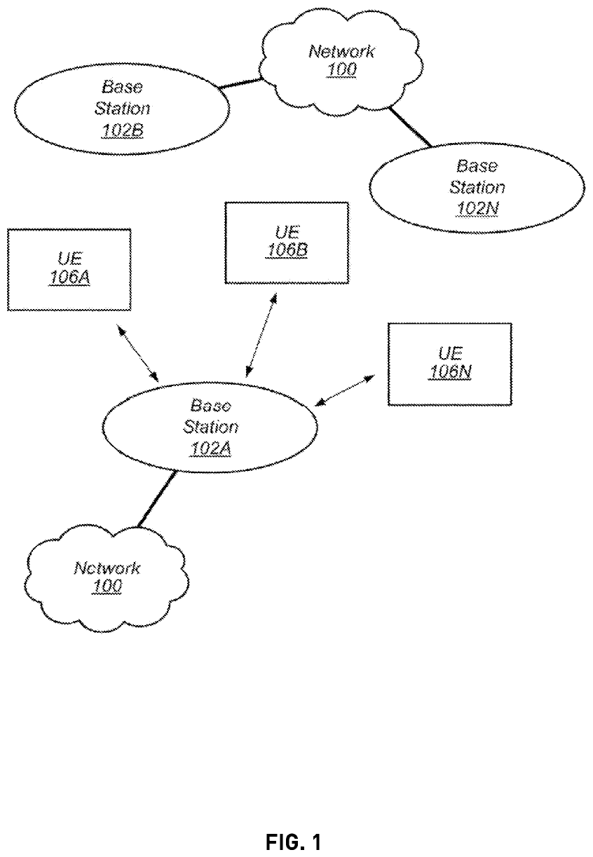

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etcetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etcetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etcetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

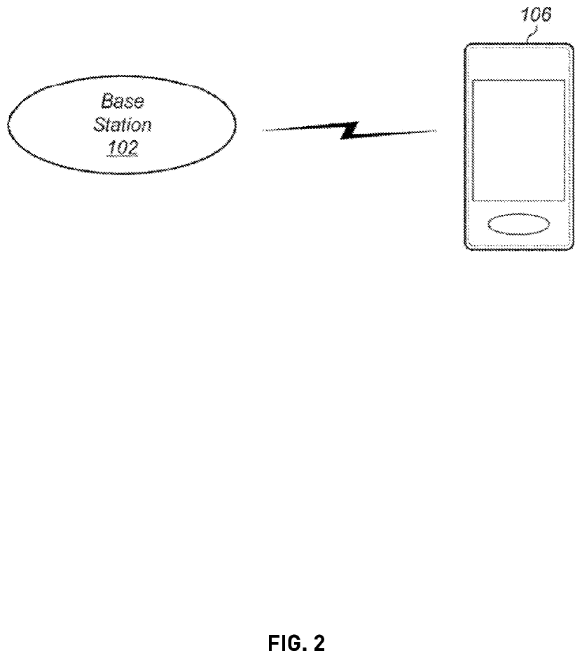

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/eHRPD), or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

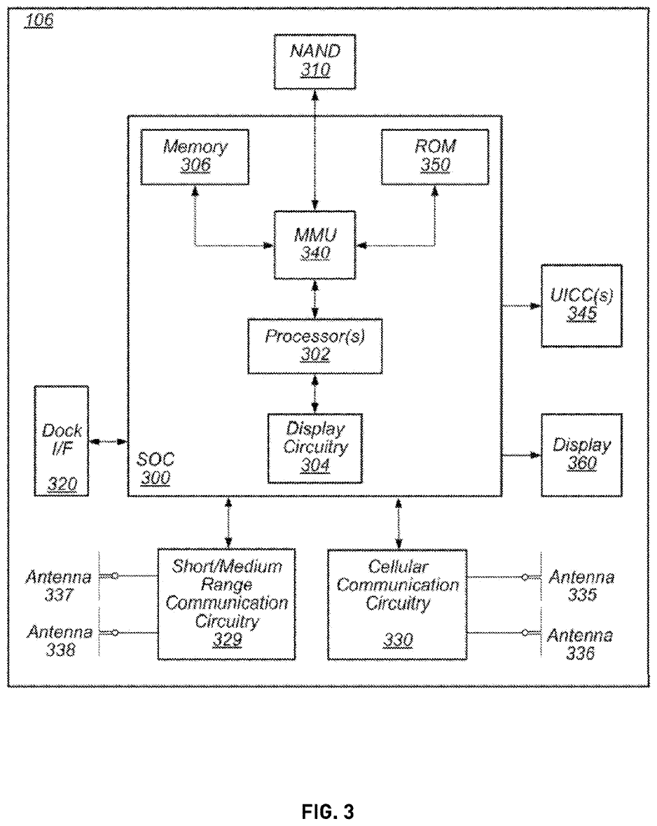

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT (e.g., 5G NR, 4G LTE, Bluetooth, Wi-Fi, etcetera) and transmit an indication that the wireless device is capable of maintaining substantially concurrent connections with the first network node and a second network node that operates according to the second RAT (e.g., 5G NR, 4G LTE, Bluetooth, Wi-Fi, etcetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the communication device 106 may include hardware and software components for implementing the above features for supporting positioning for mobile UEs in reduce-power states. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etcetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etcetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etcetera) configured to perform the functions of short range wireless communication circuitry 329.

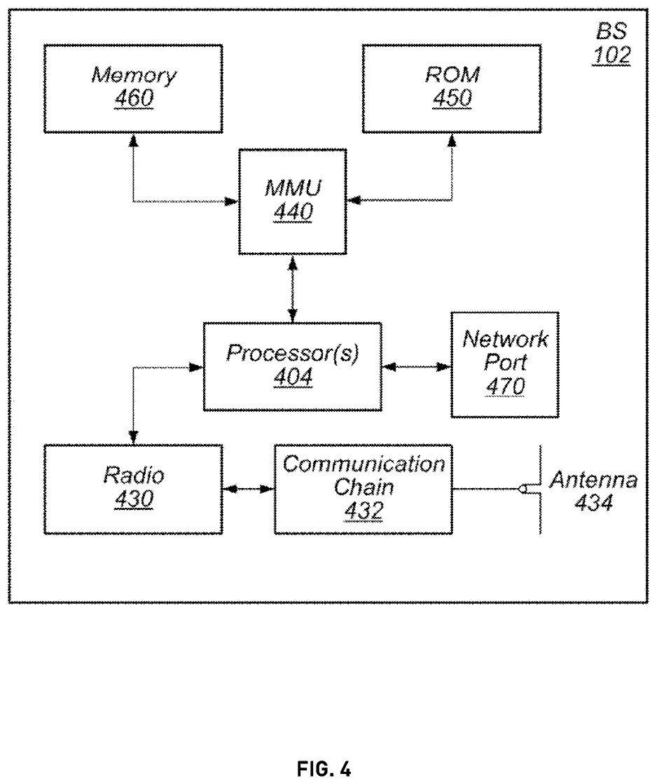

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

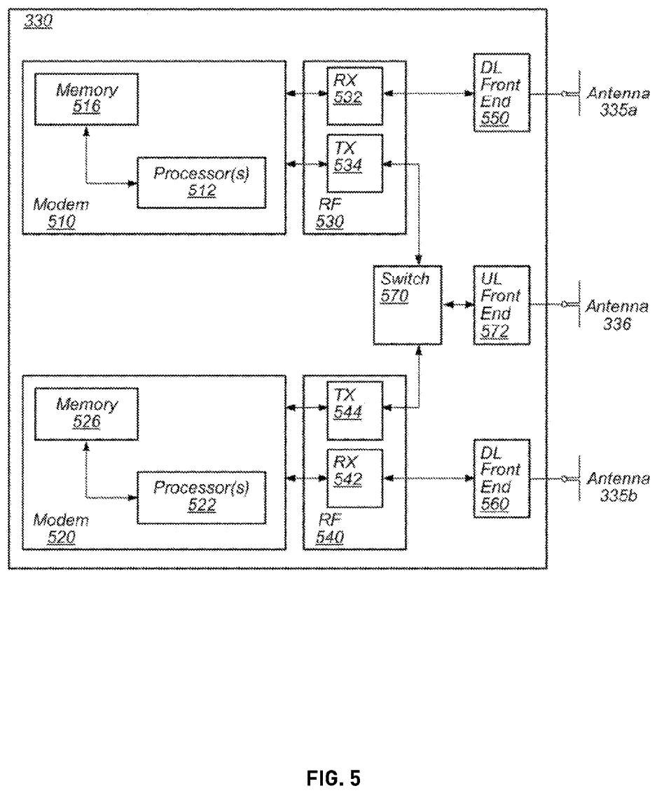

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting positioning for mobile UEs in reduce-power states, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etcetera) configured to perform the functions of processors 512.

As described herein, the modem 520 may include hardware and software components for implementing the above features for supporting positioning for mobile UEs in reduced-power states, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etcetera) configured to perform the functions of processors 522.

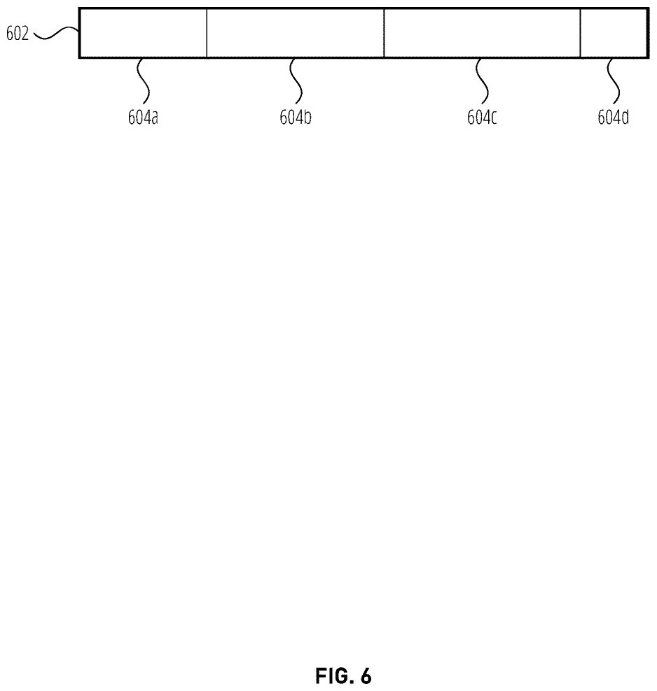

FIG. 6 illustrates a network message 602 comprising a plurality of information elements (IEs) 604a, 604b, 604c, 604d (collectively referred to as IEs 604). In various embodiments, a variety of network messages 602 composed of one or more information elements may be utilized for communication between different components. In various such embodiments, one or more network messages 602 of one or more formats may be exchanged between the one or more UEs and one or more network components to perform one or more procedures or techniques disclosed hereby. Configuring, activating, and performing positioning in low-power states may utilize the exchange of multiple network messages 602. For example, messages discussed herein may comprise and/or utilize one or more of LTE positioning protocol (LPP), NR positioning protocol a (NRPPa), and RRC messaging. It will be appreciated that the network message 602 and IEs 604 may come in a variety of formats and carry a variety of information. Oftentimes, various standards and technical specifications define the various network messages 602, IEs 604, and procedures, such as 3GPP technical specifications (e.g., TS 38.321, TS 38.321, TS 22.261, and TS 22.104). Embodiments are not limited in this context.

Various techniques for supporting positioning for mobile UEs in reduced-power states will be described in more detail below. The techniques may be utilized to enable a UE to perform low power high accuracy positioning (LPHAP). Several embodiments facilitate uplink (UL) and/or UL+downlink (DL) positioning for UEs in inactive and/or idle states in a manner that improves positioning services in 5G networks by reducing the need to transition into higher power states (e.g., a connected state). For instance, various aspects of positioning may be performed with the UE in a radio resource control (RRC) inactive or RRC idle state instead of an RRC connected state. Many embodiments include sounding reference signal (SRS) enhancements based on SRS positioning validity area may be used to reduce the need to transition into a connected state for positioning (re) configuration. In some such examples, positioning configuration groups may be utilized to enable a common positioning configuration, or portions thereof, to be utilized in multiple network cells. In various embodiments, a power metric of signals may be utilized to determine network cells in a positioning configuration group. In many embodiments, techniques are utilized to obtain, validate, or update positioning configurations and/or activate positioning transmissions at a UE in the inactive or idle state. For example, one or more of SRSp, TA, and path loss reference configurations may be obtained and/or utilized by a UE in the RRC inactive or RRC idle states. In various embodiments, the SRSp may comprise a signal embedded in the physical layer as a reference signal.

More generally, LPHAP is directed to reduced power consumption of a positioning device while keeping high localization accuracy. Oftentimes, existing techniques are unable to meet the requirements of LPHAP due, at least in part, to the excessive need for UEs to transition into a connected state to acquire updated positioning configurations to ensure high positioning accuracy. For example, with respect to use case 6 defined in TS 22.104, the LPHAP requirements include a horizontal positioning accuracy within 1 meter for 90% of UEs, a positioning interval/duty cycle between 15 and 30 seconds, and a UE battery life of 6 months to 1 year. Use case 6 relates to indoor and outdoor tracking of a workpiece in an assembly area and/or warehouse using low power periodic and triggered 5G Core Mobile Terminated Location Request (5GC-MT-LR) procedures. The embodiments in this disclosure may provide methods to ensure that these requirements are met.

Using existing techniques, from the radio layer 1 (RAN1) perspective, in RRC inactive state, reception of DL positioning reference signal (PRS) has lower priority than other DL signals/channels, such as synchronization signal blocks (SSBs), system information blocks (SIBs), control resource sets (CORSETs), random access (RA) responses, paging, and DL small data transmissions (SDTs). A UE may support, subject to capability, DL PRS processing outside and inside of the initial DL bandwidth part (BWP). For DL PRS processing outside of the initial DL BWP, the subcarrier spacing (SCS) and cyclic prefix (CP) type of the DL PRS can be the same or different as for the initial DL BWP. For DL PRS processing inside of the initial DL BWP, the SCS and CP type of DL PRS is the same as for the initial DL BWP.

Further, in existing techniques, the following options may be supported for SRS for positioning transmission by UEs in the RRC inactive state. Subject to UE capability, a UE may be configured with an SRS for positioning associated with the initial UL BWP and transmitted, during the RRC inactive state, inside the initial UL BWP with the same CP and SCS as configured for the initial UL BWP. Subject to UE capability, a UE may be configured with an SRS for positioning where frequency, location, bandwidth, SCS, and CP length are additionally configured for the transmission of the SRS for positioning during the RRC inactive state. Further, the UE will not transmit the SRS for positioning when it is expected to perform UL transmissions in the initial UL BWP in RRC inactive state. Additionally, existing techniques may perform TA validation and/or derivation of pathloss reference as defined in TS 38.321. It will be appreciated that various embodiments disclosed hereby may utilize, expand on, alter, and/or redefine one or more of the existing techniques to support positioning for UEs in reduced-power states, such as to achieve one or more of the LPHAP requirements identified above.

In various embodiments, the reduced-power states may refer to an inactive state, such as NR RRC INACTIVE (i.e., RRC inactive), and an idle state, such as NR RRC IDLE (i.e., RRC idle) states. More generally, UEs may transition between a connected state, such as NR RRC CONNECTED (i.e., RRC connected) and the reduced-power states. For example, with respect to the NR RRC states, transitioning from the connected state to the inactive state may be initiated in response to a UE receiving an RRC Release with SuspendConfig network message. A UE may initiate transitioning from the inactive state back to the connected state using a Resume network message. Transitioning from the inactive or connected states to the idle state may be initiated in response to the UE receiving an RRC Release network message. A UE may initiate transitioning from the idle state to the connected state using an RRC Setup network message. As will be described in more detail below, various embodiments disclosed hereby may utilize one or more of the RRC Release, the RRC Release with SuspendConfig, the RRC Resume and/or the RRC Setup network messages to request and/or receive data regarding positioning configurations without actually transitioning out of the inactive or idle states.

The RRC connected state supports full performance with the RRC inactive and RRC idle states supporting differing levels of reduced performance. For example, when a UE is in the RRC inactive state, the network (e.g., access and mobility management function (AMF)) expects less rapid responses to any downlink transactions because the UE must be paged before those transactions can be forwarded to the UE. However, the network can therefore apply longer supervision timers for UEs in the RRC inactive state, which can reduce resource demand on the network and improve UE battery life.

Despite the reduce performance in inactive and idle states, UEs still perform a number of operations. For example, in both the inactive and idle states, a UE performs operations including reading system information, monitoring the physical downlink control channel (PDCCH) downlink control information (DCI) using the paging radio network temporary identifier (P-RNTI), and monitoring the paging control channel (PCCH) for core network (CN) paging using the 5G shortened temporary mobile subscriber identity (5G-S-TMSI). Additionally, in the inactive state, a UE may perform RAN paging using the inactive-RNTI.

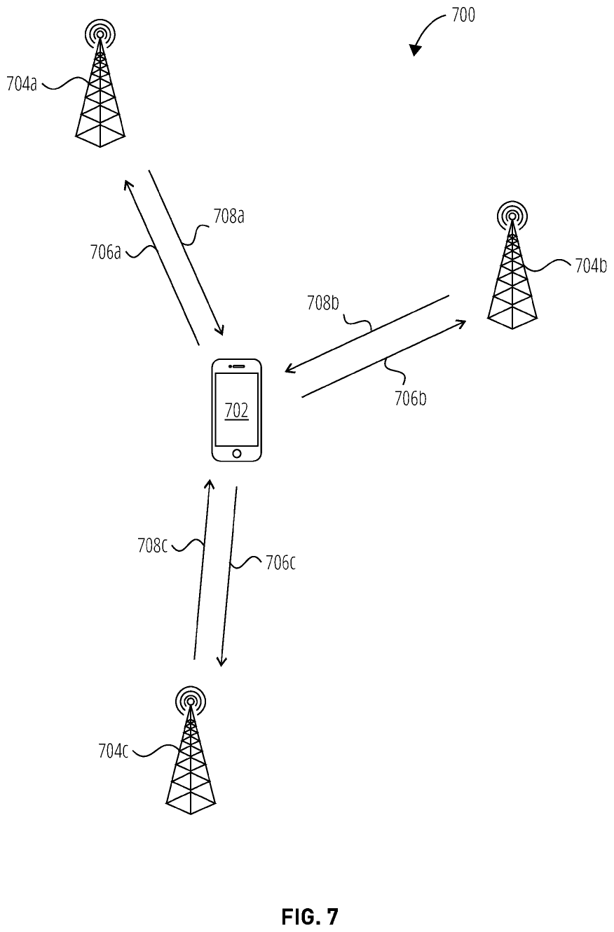

FIG. 7 illustrates various aspects of positioning in telecommunication networks according to some embodiments. FIG. 7 includes an operating environment 700 with UE 702 and base stations 704a, 704b, 704c. In the illustrated embodiment, uplink messages 706a, 706b, 706c are transmitted from the UE 702 to the base stations 704a, 704b, 704c, respectively. Similarly, downlink messages 708a, 708b, 708c are transmitted from the base stations 704a, 704b, 704c to the UE 702, respectively. These uplink and/or downlink messages may be utilized to localize the UE based on one or more of roundtrip time (RTT), angle of arrival (AoA), angle of departure (AoD), and time difference of arrival (TDOA) of the uplink and/or downlink messages. Some positioning techniques may not use bi-directional messaging. For example, UL positioning may only utilize uplink messages. Various positioning techniques may use multiple base stations. Other positioning techniques may use a single base station. For example, roundtrip time (RTT) may be combined with angle of arrival (AoA) and/or angle of departure (AoD) to perform positioning with a single base station. Accurate positioning requires a variety configurations, settings, and parameters, such as SRSp configuration, TA configuration, and pathloss reference. As described in more detail below, many embodiments disclosed hereby are directed to maintaining and using valid configurations for positioning at a UE while spending as much time as possible in the inactive or idle states. Embodiments are not limited in this context.

In existing techniques, whenever positioning configurations are invalid, a UE may have to go into the connected state to obtain a valid positioning configuration, resulting in excessive battery drain and resource requirements. Further, one or more of the positioning configuration may cause another portion (or all) of the positioning configuration to be invalidated. For example, if a TA configuration is not valid, then the SRSp configuration may be invalidated. When cell reselection is performed and the UE initiates the RRC resume procedure to a cell that is different from the cell in which the SRSp is configured, the TA timer configuration for SRS may be released. Further, the SRSp configuration may be released when the UE sends RRCResumeRequest to a cell other than the cell where the UE is released to the inactive state. The TA timer configuration of SRSp may be invalidated upon any cell reselection (even if the UE does not initiate the RRC resume procedure). It will be appreciated that various embodiments disclosed hereby may utilize, expand on, alter, and/or redefine one or more of the existing techniques to support positioning for UEs in reduced-power states, such as by making positioning configurations valid in a larger area to reduce the number of times positioning configurations need to be updated.

Accordingly, various embodiments update and/or expand the validity criteria for positioning configurations in the inactive and idle states to extend the usability of positioning configurations by reducing the frequency with which new positioning configurations are required. In many embodiments, multiple cells in an area may be defined or configured to have the same SRSp configuration properties. For example, positioning configuration groups may be utilized to enable a common positioning configuration, or portions thereof, to be utilized in multiple network cells. In various embodiments, a power metric of signals may be utilized to determine network cells in a positioning configuration group. For example, the reference signal received power (RSRP) may be compared with a reference SRSp configuration cell to determine if the cell is in the positioning configuration group.

Positioning configuration groups, which may refer to or include SRSp Valid Configuration Groups, may be defined and have network cells assigned to them in a number of ways. In several embodiments, the UE may receive a pre-configured SRS configuration of X-cells (where ‘X’ is a defined amount of one or more cells) around the primary connected cell (e.g., the configuring cell). The UE may decode the cell ID (from base station for RRC inactive and from core network for RRC idle) and check it again a list of cell IDs in the positioning configuration group. In some embodiments, the positioning configuration group label for the core network may be different from that for the base station. For example, the ID for RRC idle may include the 5G-S-TSMI and the ID for RRC inactive may include the full-RNTI. The format for the pre-configured SRS configuration may be {5G-S-TMSI1, full-RNTI1, 5G-S-TMSI2, full-RNTI2, . . . , 5G-S-TMSIn, full-RNTIn}. More generally, the group may be the same or it may be different. In many embodiments, if the group is the same, then the labeling is different due to the core network being labeled with the 5G-TSMI and base stations being labeled with the RTNI. In other words, if a UE is inactive, it uses the base station labeling (e.g., RTNI) and if the UE is idle, it uses the core network labeling (e.g., RTNI).

In some embodiments, the UE may store a plurality of positioning configurations. In some such embodiments, signaling from the network may be utilized to identify which of the plurality of positioning configurations to use. In various embodiments, the base station and/or core network may broadcast separate positioning configuration group IDs. In various such embodiments, the UE may check the broadcast positioning configuration group ID against a current positioning configuration group ID to establish validity. For example, on configuration, the UE may get the positioning configuration group ID, each cell will broadcast its own ID, and on moving to a new cell, the UE checks its current ID against the broadcast ID and decides if it is in the same positioning configuration group.

In some embodiments, the UE may periodically check RSRP against a threshold and validity holds if the RSRP is greater than a threshold value. In some such embodiments, the check occurs during paging procedures.

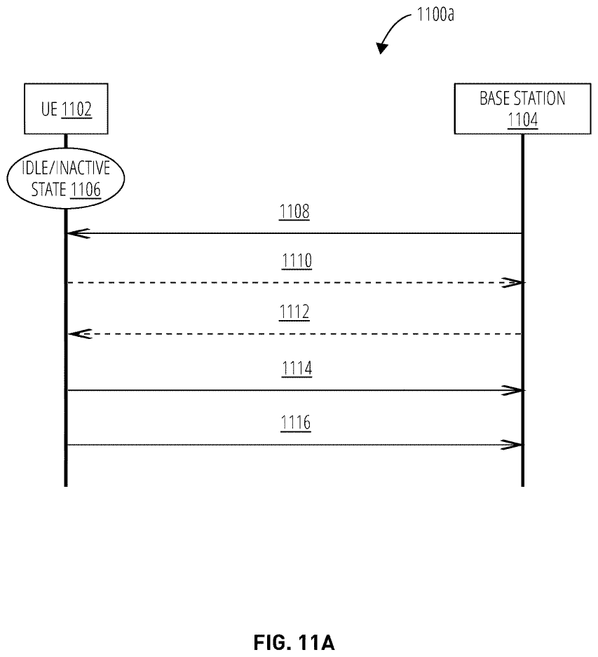

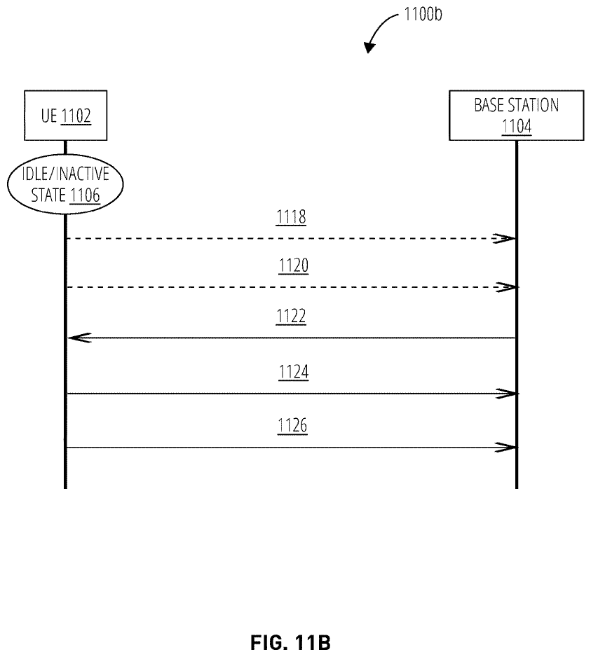

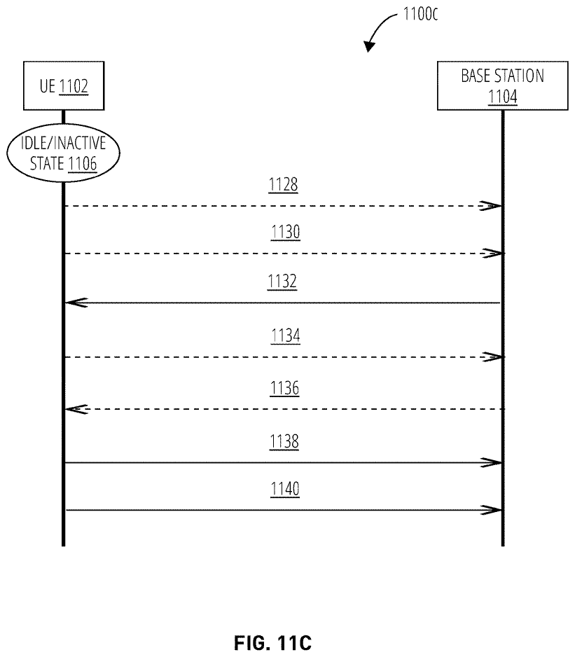

In many embodiments, when the UE is paged, it receives information on which specific positioning configuration group the cell belongs to or which specific SRSp to activate for each base station. For a UE that is not transmitting SRSp in RRC idle or RRC inactive, the network may use the paging function to activate this functionality (see e.g., FIG. 11A). During paging (e.g., in Paging message), an activation index is sent for SRSp configuration. Optionally, this may be piggybacked on the existing paging function or a new SRSp paging function may be designed (with SRSp RNTI) to indicate SRSp configuration update. In some embodiments, a bit in PDCCH may be used to indicate a need for PDSCH decode of SRSp configuration or RRCRelease.

Regarding cell reselection criteria, when cell reselection is performed and the UE initiates RRC resume procedure in a new cell which is different from the cell in which the SRSp is configured, the TA timer configuration for SRS may be released if the new cell is in a different positioning configuration group. However, the TA timer configuration is not released if the new cell is in the same positioning configuration group. Regarding RRCResumeRequest criteria, the SRSp configuration may be released when the UE sends the RRCResumeRequest to a new cell other than the cell where the UE is released to inactive or idle states if the new cell is in a different positioning configuration group. However, the SRSp configuration is not released if the new cell is in the same positioning configuration group. Regarding TA timer configuration criteria, TA timer configuration of SRSP may be invalidated upon any cell reselection to a new cell that is not within the same positioning configuration group (even if the UE does not initiate the RRC resume procedure).

In some embodiments, TA invalidity may be determined by comparing a stored downlink pathloss RSRP value and the current RSRP value of the downlink pathloss reference. For example, a TA configuration may remain valid as long as the value has not increased/decreased by a threshold amount (e.g., more than inactivePosSRS-RSRP-Change Threshold) and a time alignment timer (e.g., inactivePosSRS-TimeAlignmentTimer) is still running.

Several embodiments may update the RSRP change threshold parameters for the inactive state. This may account for the issue where the UE may move between cells in the same positioning configuration group but have a TA validity issue in the new cell. In some embodiments, a single parameter may be used for each cell in the positioning configuration group (e.g., inactivePosSRS-RSRP-ChangeThreshold-R18). In other embodiments, different parameters for the cell configuring the SRSp and other cells in the same positioning configuration group may be utilized. In other words, different change thresholds may be used for different network cells in the positioning configuration group (e.g., inactivePosSRS-RSRP-Change Threshold-Configuringcell and inactivePosSRS-RSRP-Change Threshold-Neighborcell).

In many embodiments, if the current RSRP has not increased/decreased by more than inactivePosSRS-RSRP-Change Threshold-Configuringcell/inactivePosSRS-RRSRP-ChangeThreshold-R18 and UE initiates RRC resume procedure in which the UE sends RRCResumeRequest to the cell configuring SRSp (i.e., same cell), then the TA configuration is valid. Additionally, or alternatively, if the current RSRP has not increased/decreased by more than inactivePosSRS-RSRP-Change Threshold-Neighborcell/inactivePosSRS-RRSRP-CHangeThreshold-R18 and UE initiates RRC resume procedure in which the UE sends RRCResumeRequest to a different cell in the same positioning configuration group, then the TA configuration is valid. Various such embodiments may utilize one or more of inactive PosSRS-RSRP-Change Threshold-Configuringcell, inactivePosSRS-RSRP-Change Threshold-Neighborcell, and inactivePosSRS-RRSRP-CHangeThreshold-R18 in SRS-PosRRC-InactiveConfig-Rxx in an RRCRelease Message to convey the relevant information, such as change thresholds.

Similar to with respect to the inactive state, several embodiments may update the RSRP change threshold parameters for the idle state. This may account for the issue where the UE may move between cells in the same positioning configuration group but have a TA validity issue in the new cell. In some embodiments, a single parameter may be used for each cell in the positioning configuration group (e.g., idlePosSRS-RSRP-ChangeThreshold-R18). In other embodiments, different parameters for the cell configuring the SRSp and other cells in the same positioning configuration group may be utilized. In other words, different change thresholds may be used for different network cells in the positioning configuration group (e.g., idlePosSRS-RSRP-ChangeThreshold-Configuringcell and idle PosSRS-RSRP-Change Threshold-Neighborcell).

In many embodiments, if the current RSRP has not increased/decreased by more than idle PosSRS-RSRP-Change Threshold-Configuringcell/inactivePosSRS-RRSRP-CHangeThreshold-R18 and UE initiates RRC resume procedure in which the UE sends RRCResumeRequest to the cell configuring SRSp (i.e., same cell), then the TA configuration is valid. Additionally, or alternatively, if the current RSRP has not increased/decreased by more than idlePosSRS-RSRP-Change Threshold-Neighborcell/idlePosSRS-RRSRP-ChangeThreshold-R18 and UE initiates RRC resume procedure in which the UE sends RRCResumeRequest to a different cell in the same positioning configuration group, then the TA configuration is valid. Various such embodiments may utilize one or more of idlePosSRS-RSRP-Change Threshold-Configuringcell, idlePosSRS-RSRP-Change Threshold-Neighborcell, and idlePosSRS-RRSRP-CHangeThreshold-R18 in SRS-PosRRC-idleConfig-Rxx in an RRCRelease Message to convey the relevant information, such as change thresholds. Alternatively, in some embodiments, the inactive and idle states may use the same parameters.

Many embodiments may enable SRSp transmission in RRC idle states. Many such embodiments include enhancements on SRSp to support UE mobility in RRC idle states, such that the UE does not need to frequently enter RRC connected state to update the SRS (re) configurations, thereby reducing power consumption of the UE. In some embodiments, the same SRSp configuration defined in RRCRelease may be utilized for RRC inactive and RRC idle states. In other embodiments, a different SRSp configuration may be defined for RRC idle states. Exemplary definitions are provided below in Tables 1 and 2 for RRC inactive and RRC idle states, respectively.

TABLE 1
SRS-PosRRC-Inactive-r17 ::= OCTET STRING (CONTAINING SRS-PosRRC-InactiveConfig-r17)
SRS-PosRRC-InactiveConfig-r17 ::= SEQUENCE {

| | | |
|---|---|---|
| srs-PosConfigNUL-r17 | SRS-PosConfig-r17 | OPTIONAL, |
| srs-PosConfigSUL-r17 | SRS-PosConfig-r17 | OPTIONAL, |
| bwp-NUL-r17 | BWP | OPTIONAL, |
| bwp-SUL-r17 | BWP | OPTIONAL, |

| | |
|---|---|
| inactivePosSRS-TimeAlignmentTimer-r17 TimeAlignmentTimer | OPTIONAL, |
| inactivePosSRS-RSRP-changeThreshold-r17 RSRP-ChangeThreshold-r17 | OPTIONAL |

}

TABLE 2
SRS-PosRRC-Idle-r18 ::= OCTET STRING (CONTAINING SRS-PosRRC-IdleConfig-r17)
SRS-PosRRC-IdleConfig-r18 ::= SEQUENCE {

| | | |
|---|---|---|
| srs-PosConfigNUL-r18 | SRS-PosConfig-r18 | OPTIONAL, |
| srs-PosConfigSUL-r18 | SRS-PosConfig-r18 | OPTIONAL, |
| bwp-NUL-r18 | BWP | OPTIONAL, |
| bwp-SUL-r18 | BWP | OPTIONAL, |

| | |
|---|---|
| IdlePosSRS-TimeAlignmentTimer-r18 TimeAlignmentTimer | OPTIONAL, |
| IdlePosSRS-RSRP-changeThreshold-r18 RSRP-ChangeThreshold-r18 | OPTIONAL |

}

Several embodiments support SRS for positioning configurations in multiple cells by enabling coordinated configuration across multiple cells. To prevent issues like interference or to account for the different spatial relation information for the SPS configuration when a UE transmits to a different cell, embodiments may include some cell-common and/or some cell-dedicated parameters in the configuration. In some embodiments, all parameters may be common. In other embodiments, a pre-determined set of parameters may be common. In various embodiments, the configuration may include information indicating which parameters are common. In one example, the SRSp configuration in a coordinated set of cells may be configured in a manner to limit the interference by coordinated setting the spatial relations (beams) that transmit at the same time or by ensuring that the SRSps for the UEs are transmitted at different times. For example, if first and second UEs have Spatial Relation configurations (beams) that would result in interference, the first UE may be configured to transmit at times t1, t2, . . . , tn, while the second UE may be configured to transmit at times t1+n1, t2+n2, . . . , tn+nn. The UEs may be configured separately, or they may be configured in the same group with a common time of t1, t2, . . . , tn, but with the second UE having a UE specific parameter of delta_n to enable n1, n2 and nn.

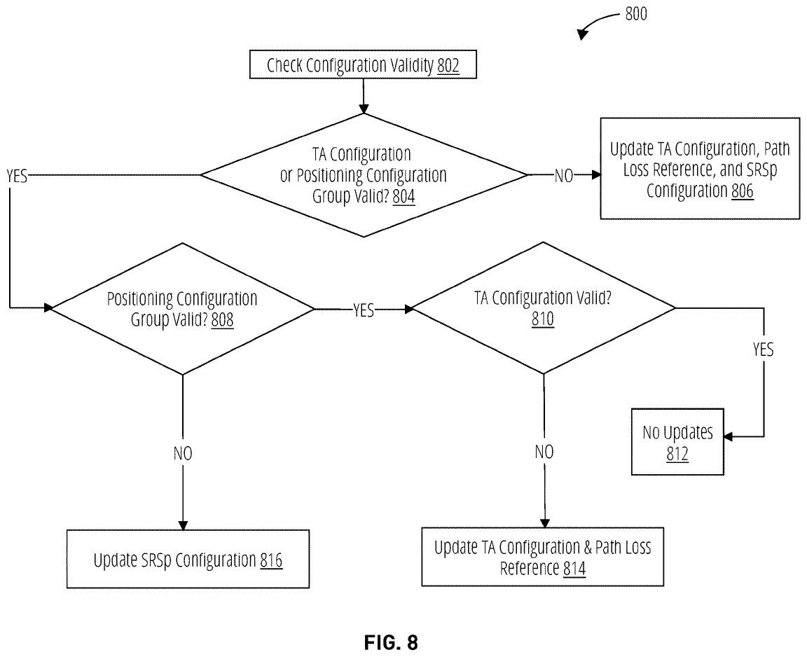

FIG. 8 illustrates a logic flow 800 for updating positioning configurations according to some embodiments. In some embodiments, different portions of positioning configurations may be treated together (e.g., if one is updated, then all are updated). However, in other embodiments, different portions of positioning configurations may be treated separately. For example, TA configuration validity may be treated as a separate issue from positioning configuration groups. In some such examples, if the TA configuration is invalid, rather than invalidating the SRSp configuration, a TA configuration procedure to update the TA and/or the TA validation parameters may be initiated. Logic flow 800 illustrates a flow chart for determining when and which portions of positioning configurations to update in a manner that separates TA configuration validity and positioning configuration groups. Embodiments are not limited in this context.

Logic flow 800 beings at block 802. At block 802 configuration validity is checked. For example, the validity of the TA configuration and the positioning configuration group may be determined. Proceeding to decision block 804, it may be determined whether the TA configuration or the positioning configuration group are valid. For example, the TA configuration may be determined to be invalid based on a RSRP value in a second network cell being outside of a change threshold with respect to a stored downlink pathloss reference RSRP value. In another example, it may be determined whether the current network cell is included in the same positioning configuration group as the configuring network cell.

If the TA configuration and the positioning configuration group are both invalid, then the logic flow 800 may proceed to block 806. At block 806, the TA configuration, pathloss reference, and SRSp configuration may be updated. However, if the TA configuration or the positioning configuration group is valid, then the logic flow 800 may proceed to decision block 808. At decision block 808, if the positioning configuration group is invalid, the logic flow proceeds to block 816 and updates the SRSp configuration. Otherwise, the logic flow 800 proceeds to decision block 810. At block 810, if the TA configuration group is invalid, the logic flow proceeds to block 814 and the TA configuration and pathloss reference is updated. Otherwise, the logic flow 800 proceeds to block 812 and no updates are performed.

In other words, if the TA configuration and positioning configuration group are valid, then no updates are performed. If the TA configuration is valid and positioning configuration group is invalid, then the SRSp configuration is updated. If the TA configuration is invalid and positioning configuration group is valid, then the TA configuration (e.g., TA parameters) and the pathloss reference are updated. If the TA configuration and positioning configuration group are invalid, then the TA configuration, the pathloss reference, and the SRSp configuration are updated.

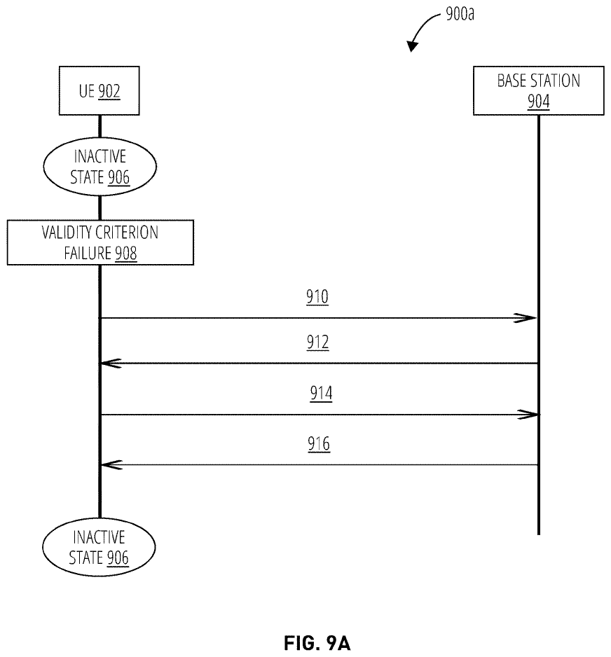

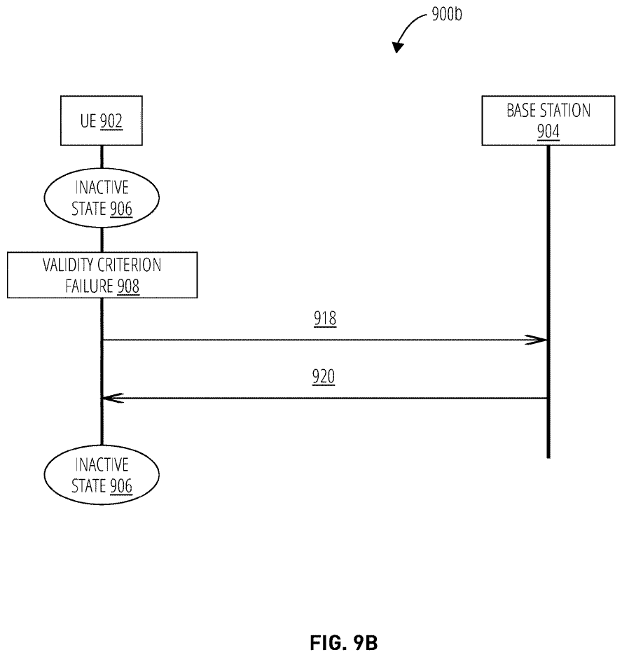

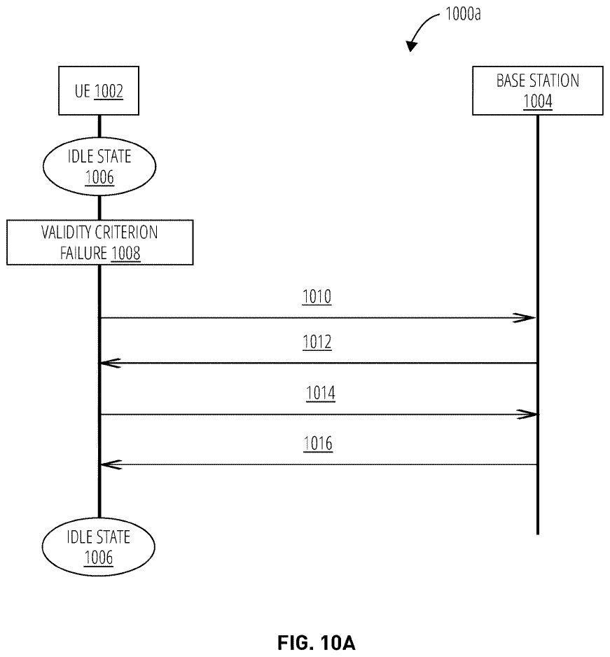

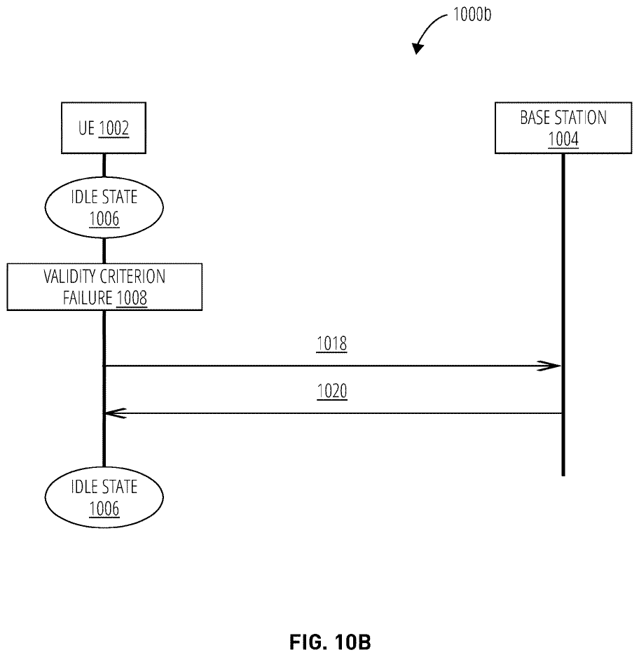

As previously mentioned, transitioning to RRC connected state to obtain SRS (re) configuration increases power consumption. Accordingly, various embodiments disclosed hereby extend the usability of positioning configurations, such as by reducing the frequency with which new positioning configurations are required. Additionally, or alternatively, several embodiments disclosed hereby utilize techniques and procedures to obtain, validate, or update positioning configurations (e.g., positioning SRS (SRSp) configurations, timing advance (TA) configurations, path loss references, and the like) and/or activate positioning transmissions at a UE with the UE in an inactive or idle state. As discussed in more detail below, such as with respect to FIGS. 9A-10B, in several such embodiments, the UE may request an update for the positioning configuration (e.g., SRS) from the base station when in the RRC inactive state and from the core network when in the RRC idle state using a random access channel (RACH) based procedure. For example, the request of updating the SRS configuration may be sent by RRC ResumeRequest when in the inactive state and by the RRC SetupRequest when in the idle state. The update (e.g., new positioning configuration including TA parameters and/or SRSp configuration) may be sent by the RRC Release IE. Other examples may work the other way around, such as with the network initiating the update. For instance, an update SRSPconfig message may be created with a mini RRCRelease. In this and other instances, a mini RRCRelease may be utilized to reduce the size of the message.

FIGS. 9A and 9B illustrate exemplary process diagrams 900a, 900b for updating positioning configurations in an inactive state 906 according to some embodiments. More specifically, FIG. 9A illustrates a four-step RACH procedure for updating positioning configuration in the inactive state 906 and FIG. 9B illustrates a two-step RACH procedure for updating positioning configuration in the inactive state 906. The process diagrams 900a, 900b both include UE 902, base station 904, inactive state 906, and validity criterion failure 908. Further, each of the process diagrams 900a, 900b begin with the UE 902 in the inactive state 906 and having a validity criterion failure 908 (e.g., one or more portions of the positioning configuration is invalid (see e.g., FIG. 8)).

Referring to process diagram 900a of FIG. 9A, in response to the validity criterion failure 908, UE 902 may transmit, in the inactive state 906, a network message 910 to base station 904. In various embodiments, the network message 910 may include a Msg1: PRACH preamble. In response to the first network message 910, the base station 904 (or network) may send a network message 912 to the base station 904. In some embodiments, the network message 912 may include a Msg2: RA Response. In response to the network message 912, UE 902 may send a network message 914 to the base station 904. In many embodiments, the network message 914 may include a Msg3: RRC ResumeRequest+{SRSpConfig, SRSpTA}. In response to the network message 914, the base station 904 may send a network message 916 to the UE 902. In several embodiments, the network message 916 may include a Msg4: RRC Release with SuspendConfig. In several such embodiments, the RRC Release may include the updated SRSp configuration and/or other positioning configuration data. During the procedures of process diagram 900a, UE 902 may remain in the inactive state 906. In many embodiments, process diagram 900a may be enabled through a ResumeCause defined in the RRC Resume Request message specification. For example, ResumeCause Enumerated {SRSpConfig, SRSpTA, SRPpConfigTA} may be utilized.

Referring to process diagram 900b of FIG. 9B, in response to the validity criterion failure 908, UE 902 may transmit a network message 918 to base station 904. In various embodiments, the network message 918 may include a MsgA: PRACH preamble+PUSCH carrying RRC Resume Request+{SRSpConfig, SRSpTA}. In response to the network message 918, the base station 904 (or network) may send a network message 920 to the base station 904. In some embodiments, the network message 920 may include a MsgB: Success RA response carrying RRC Release with SuspendConfig. In some such embodiments, the RRC Release may include the updated SRSp configuration and/or other positioning configuration data. In some embodiments, the RRC Release may utilize SRS-PosRRC-inactiveConfig-r17 for positioning configuration data. During the procedures of process diagram 900a, UE 902 may remain in the inactive state 906. In several embodiments, the updated positioning configuration may be provided in a success random access response network message.

FIGS. 10A and 10B illustrate exemplary process diagrams 1000a, 1000b for updating positioning configurations in an idle state 1006 according to some embodiments. More specifically, FIG. 10A illustrates a four-step RACH procedure for updating positioning configuration in the idle state 1006 and FIG. 10B illustrates a two-step RACH procedure for updating positioning configuration in the idle state 1006. The process diagrams 1000a, 1000b both include UE 1002, base station 1004, idle state 1006, and validity criterion failure 1008. Further, each of the process diagrams 1000a, 1000b begin with the UE 1002 in the idle state 1006 and having a validity criterion failure 1008 (e.g., one or more portions of the positioning configuration is invalid (see e.g., FIG. 8)).

Referring to process diagram 1000a of FIG. 10A, in response to the validity criterion failure 1008, UE 1002 may transmit, in the idle state 1006, a network message 1010 to base station 1004. In various embodiments, the network message 1010 may include a Msg1: PRACH preamble. In response to the first network message 1010, the base station 1004 (or network) may send a network message 1012 to the base station 1004. In some embodiments, the network message 1012 may include a Msg2: RA Response. In response to the network message 1012, UE 1002 may send a network message 1014 to the base station 1004. In many embodiments, the network message base station 1004 may include a Msg3: RRC SetupRequest+{SRSpConfig, SRSpTA}. In response to the network message 1014, the base station 1004 may send a network message 1016 to the UE 1002. In several embodiments, the network message 1016 may include a Msg4: RRC Release. In several such embodiments, the RRC Release may include the updated SRSp configuration and/or other positioning configuration data. During the procedures of process diagram 1000a, UE 1002 may remain in the idle state 1006. In many embodiments, process diagram 1000a may be enabled through an EstablishmentCause defined in the RRC SetupRequest message specification. For example, EstablishmentCause Enumerated {SRSpConfig, SRSpTA, SRPpConfigTA} may be utilized.

Referring to process diagram 1000b of FIG. 10B, in response to the validity criterion failure 1008, UE 1002 may transmit a network message 1018 to base station 1004. In various embodiments, the network message 1018 may include a MsgA: PRACH preamble+PUSCH carrying RRC Setup Request+{SRSpConfig, SRSpTA}. In response to the network message 1018, the base station 1004 (or network) may send a network message 1020 to the base station 1004. In some embodiments, the network message 1020 may include a MsgB: Success RA response carrying RRC Release. In several such embodiments, the RRC Release may include the updated SRSp configuration and/or other positioning configuration data. In some embodiments, the RRC Release may utilize SRS-PosRRC-IdleConfig-r18 for positioning configuration data. During the procedures of process diagram 1000b, UE 1002 may remain in the idle state 1006.

FIGS. 11A-11C illustrate exemplary process diagrams 1100a, 1100b, 1100c for positioning activation procedures according to some embodiments. The procedures of process diagrams 1100a, 1100b, 1100c may enable SRS positioning activation procedures to be performed with the UE in the idle or inactive state. In several embodiments, the network may activate a specific (set of) SRS configuration in the UE in RRC idle or RRC inactive states. FIG. 11A illustrates process diagram 1100a for a network to cause a UE 1102 to activate positioning transmissions, FIG. 11B illustrates process diagram 1100B for a network to cause UE 1102 to update configuration and activate positioning transmissions, and FIG. 11C illustrates process diagram 1100C for a network to cause UE 1102 to verify configuration and activate positioning transmissions. The process diagrams 1100a, 1100b, 1100c each include UE 1102, base station 1104, and idle/inactive state 1106. It will be appreciated that in this and other embodiments, a base station (e.g., base station 1104) may simply relay data to the UE 1102 from other network components, such as the core network. Further, each of the process diagrams 1100a, 1100b, 1100c begin with the UE 1102 in the idle or inactive state (e.g., idle/inactive state 1106).

Referring to FIG. 11A, process diagram 1100a may correspond to initial activation, such as a situation in which the UE 1102 is not sending SRSp in the idle or inactive state and the network would like the UE 1102 to start doing so. Accordingly, base station 1104 may transmit network message 1108 to UE 1102. In various embodiments, the network message 1108 may include a network activation indication with or without a positioning configuration (e.g., the SRSp configuration). If network message 1108 does not include the positioning configuration, in response to network message 1108, UE 1102 may send network message 1110 to base station 1104 with a configuration request, such as using PRACH. In response to network message 1110, the base station 1104 may send network message 1112 to base station 1104. In several embodiments, network message 1112 may include a configuration response. In several such embodiments, the configuration response may include a positioning configuration (e.g., an SRSp configuration and/or a TA configuration). However, if network message 1108 includes a positioning configuration (e.g., the SRSp configuration), network messages 1110, 1112 may not be exchanged. Regardless, network messages 1114, 1116 may include SRSp transmissions transmitted from the UE 1102 to base station 1104 according to the positioning configuration. In many embodiments, the SRSp transmissions may be sent on a periodic basis.

Referring to FIG. 11B, process diagram 1100b may correspond to periodic activation, such as a situation in which the UE 1102 is sending SRSp in the idle or inactive state and the network would like the UE 1102 to update configuration and start SRSp transmission based on the updated configuration. In various embodiments, the UE may be sent a new SRSp configuration without having to initiate any new request. Accordingly, UE 1102 may transmit network messages 1118, 1120 to base station 1104 as SRSp transmissions. In response to the network determining it would like to update the positioning configuration of the UE 1102, base station 1104 may send network message 1122 to base station 1104. In various embodiments, the network message 1122 may include a network activation indication with a positioning configuration (e.g., the SRSp configuration). In response, UE 1102 may transmit network messages 1124, 1126 to base station 1104 according to the positioning configuration received in network message 1122. In many embodiments, the network messages 1124, 1126 include SRSp transmissions. In many such embodiments, the SRSp transmissions may be sent on a periodic basis.

Referring to FIG. 11C, process diagram 1100c may correspond to on-demand activation, such as a situation in which the network (e.g., base station) sends an explicit positioning configuration validity indicator. In some embodiments, the validity indicator may include a positioning configuration group ID. For example, the UE 1102 may be sending SRSp in the idle or inactive state, the UE may then receive a new SRSp indicator (e.g., corresponding to a positioning configuration group), and the UE may compare the indicator against its current indicator to determine whether to ask for an updated configuration.

Accordingly, UE 1102 may transmit network messages 1128, 1130 to base station 1104 as SRSp transmissions. Subsequently, the base station 1104 may send network message 1132 to UE 1102. The network message 1132 may include an activation indication associated with a positioning configuration (e.g., SRSp configuration) the network wants the UE 1102 to use. In response, the UE 1102 may check the indication against its current configuration. If the current configuration is different, the UE 1102 may send a configuration request in network message 1134 to the base station 1104 and receive a configuration response in network message 1136 from the 1104 with the configuration corresponding to the activation indication received in network message 1132. However, if the current configuration is the same, network messages 1134, 1136 may not be exchanged. Regardless, network messages 1138, 1140 may include SRSp transmissions transmitted from the UE 1102 to base station 1104 according to the positioning configuration corresponding to the activation indication. In many embodiments, the SRSp transmissions may be sent on a periodic basis.

More generally, the positioning activation procedures of FIGS. 11A-11C may be UE specific, network cell specific, and/or multi-cell specific (e.g., positioning configuration group). In various embodiments, a specific UE may have the same or different configuration sent to it during the paging procedure on different cells. In some embodiments, a specific UE may have some common configuration across multiple cells and different cell specific information in each cell. Further, the signaling (e.g., exchange of network messages) may utilize one or more of paging messages, SIB messages, RRC Release messages, and/or SPSpConfig messages.

In various embodiments, positioning configurations (e.g., SRSp configuration information) may be transferred in an existing SIB. For example, information may be added to the SIB and the UE may utilize a RACH procedure to request the information when needed. In some embodiments, information may be added to CellAccessRelatedInfo in SIB1. In some such embodiments, the TrackingArea field: BitString {24 bits} may be used. In various embodiments, the RANAreaCode {0 to 255} may be used. In many embodiments, a new field SRSpArea may be created with SRSp validity {0 to 255}. In many embodiments, information may be added to SIB3/SIB4. For example, IntraFreqNeighborList: SRSpArea may be used. In several embodiments, for periodic SIB update si-SchedulingInfo parameter may be set in SIB 1 for SIB3/SIB4. For example, systemInformation AreaID: BitString {24 bits} may be used. In another example, a new field SRSpAreaID: either BitString {x-bits} or integer {0 to 255} may be used. In various embodiments, periodic SIB may be utilized for embodiments related to process diagram 1100b, while periodic or on-demand SIB may be used for embodiments related to process diagram 1100c.

In some embodiments, positioning configurations (e.g., SRSp configuration information) may be transferred in an SI-like message. In some such embodiments, the SI-like message may be used to transfer Area information (e.g., activation indications or positioning configuration groups) or the entire configuration. For example, a new SRSp specific SIB may be specified. In another embodiment, an updated RRC Release message may be utilized. In yet another embodiment, a new SRSpRRCRelease message containing only SRSp specific information may be utilized. The SI-like message may be utilized for embodiments related to one or more of initial activation (e.g., process diagram 1100a), periodic (e.g., process diagram 1100b), or on-demand (e.g., process diagram 1100c).

In many embodiments, positioning configuration (e.g., SRSp configuration information) may be transferred using a paging procedure to activate SRSp transmission in idle or inactive states. For example, a positioning configuration group (e.g., SRSp Valid Configuration Group) parameter ID may be added to the Paging Record List. In some embodiments, for initial activation and/or on-demand, the UE may compare the ID to its current ID. In various embodiments, for initial activation and/or periodic, the UE may activate a (pre) configured positioning configuration based on the parameter. In another example, a media access control (MAC) control element (CE) may be added that includes information to activate a (pre) configured positioning configuration (e.g., from a set of preconfigured positioning configurations stored by the UE). In yet another example, the payload of paging PDSCH may add a separate RRCRelease message to send the positioning configuration (e.g., SRSp configuration) in.

In various embodiments, the payload of the paging PDCCH may be updated to signal that the UE request for a new positioning configuration change. In various such embodiments, the UE may initiate PRACH procedure to request the new positioning configuration (e.g., SRSp configuration). In other embodiments a new PDCCH (separate from the paging PDCCH) may be created to indicate a need for configuration update, such as for initial activation. For example, the new PDCCH may indicate that the UE should initiate request for updated configuration. In another example, the new PDCCH may indicate a resource of the PDSCH containing either the actual SRSpConfig (e.g., in RRCRelease) or a MAC CE payload to activate a previously (pre) configured SRSpConfig.

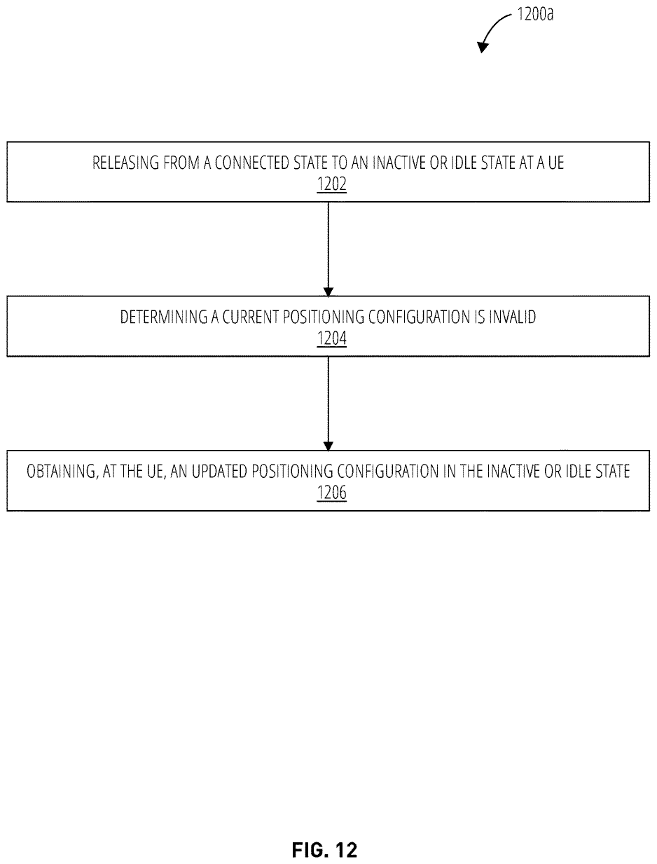

FIG. 12 illustrates a logic flow 1200 of an exemplary technique for obtaining an updated positioning configuration according to some embodiments. Aspects of logic flow 1200 may relate to various embodiments described hereby. Logic flow 1200 may begin at block 1202. Block 1202 may include releasing from a connected state to an inactive or idles state at a UE. For example, UE 702 may transition from a connected state to an inactive state. Continuing to block 1204, a current positioning configuration may be determined as invalid. For example, UE 702 may implement logic flow 800 to determine a current positioning configuration is invalid. Proceeding to block 1206, an updated positioning configuration may be obtained at the UE with the UE in the inactive or idle state. For example, a RACH procedure (see e.g., process diagrams 900a, 900b, 1000a, 1000b) may be utilized by the UE to obtain the updated positioning configuration.

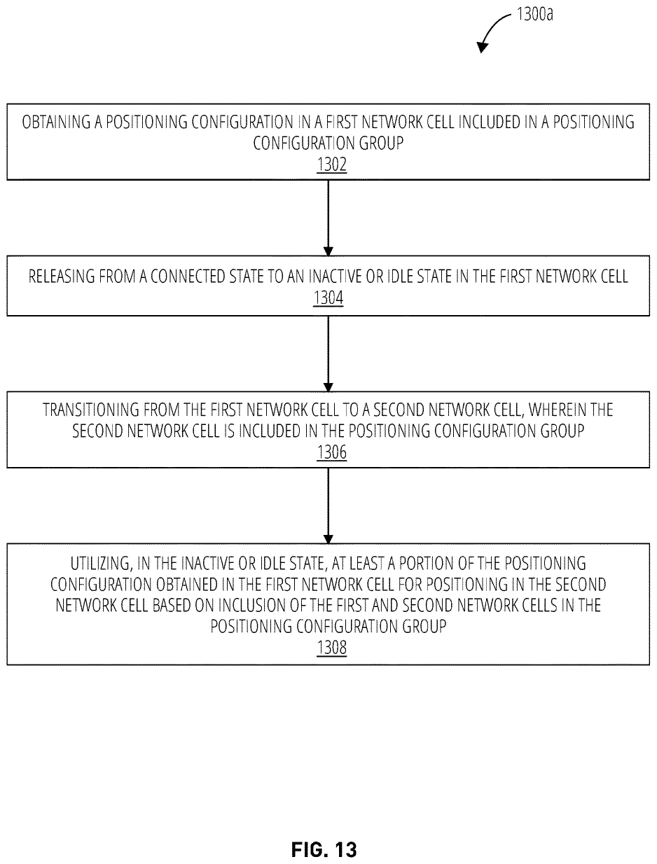

FIG. 13 illustrates a logic flow 1300 of an exemplary technique for positioning configuration groups according to some embodiments. Aspects of logic flow 1300 may relate to various embodiments described hereby. Logic flow 1300 may begin at block 1302. Block 1302 may include obtaining a positioning configuration in a first network cell included in a positioning configuration group. For example, UE 702 may obtain a positioning configuration in a first network cell corresponding to base station 704a. Additionally, the first network cell may belong to a first positioning configuration group.

Continuing to block 1304, the UE may release from a connected state to an inactive or idle state in the first network cell. For example, UE 702 may release from a connected state to an inactive state in response to receipt of a RRC Release with SuspendConfig network message from base station 704a. Proceeding to block 1306, the UE may transition (e.g., cell reselection, etcetera) from the first network cell to a second network cell included in the positioning configuration group. For example, UE 702 may transition from the first network cell corresponding to base station 704a to a second network cell corresponding to base station 704b. Further, the second network cell corresponding to base station 704b may be included in the same positioning configuration group as the first network cell corresponding to base station 704a. At block 1308, the UE may utilize, in the inactive or idle state, at least a portion of the positioning configuration obtained in the first network cell for positioning in the second network cell based on inclusion of the first and second network cells in the positioning configuration group. For example, UE 702 may utilize the positioning configuration obtained in the first network cell in the second network cell for SRSp transmissions.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etcetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a computer-implemented method, comprising obtaining a positioning configuration in a first network cell that is included in a positioning configuration group; releasing from a connected state to an inactive or idle state in the first network cell; transitioning from the first network cell to a second network cell, wherein the second network cell is included in the positioning configuration group; and utilizing, in the inactive or idle state, at least a portion of the positioning configuration obtained in the first network cell for positioning in the second network cell based on inclusion of the first and second network cells in the positioning configuration group.

Example 2 is the computer-implemented method of Example 1 that may optionally include determining a timing advance (TA) configuration is invalid in the second network cell; and utilizing a physical random access channel (PRACH) procedure to update the TA configuration for the second network cell.

Example 3 is the computer-implemented method of Example 2 that may optionally include determining the TA configuration is invalid based on a reference signal received power (RSRP) value in the second network cell being outside of a change threshold with respect to a stored downlink pathloss reference RSRP value.

Example 4 is the computer-implemented method of Example 3 that may optionally include that the change threshold is different for each network cell in the positioning configuration group.

Example 5 is the computer-implemented method of Example 4 that may optionally include that the change threshold is the same for each network cell in the positioning configuration group.

Example 6 is the computer-implemented method of Example 3 that may optionally include utilizing the PRACH procedure to update a path loss reference for the second network cell.

Example 7 is the computer-implemented method of Example 1 that may optionally include that the positioning configuration includes a positioning sounding reference signal (SRSp) configuration and a timing advance (TA) configuration.

Example 8 is the computer-implemented method of Example 1 that may optionally include that the positioning configuration includes a positioning sounding reference signal (SRSp) configuration.

Example 9 is the computer-implemented method of Example 1 that may optionally include releasing from the connected state to the inactive state in the first network cell; and determining, in the inactive state, the second network cell is in the positioning configuration group based on a core network cell identifier.

Example 10 is the computer-implemented method of Example 9 that may optionally include that the core network cell identifier comprises a radio network temporary identifier (RNTI).

Example 11 is the computer-implemented method of Example 1 that may optionally include releasing from the connected state to the idle state in the first network cell; and determining, in the idle state, the second network cell is in the positioning configuration group based on a base station cell identifier.

Example 12 is the computer-implemented method of Example 11 that may optionally include that the base station cell identifier comprises a temporary mobile subscriber identity (TMSI).

Example 13 is the computer-implemented method of Example 1 that may optionally include identifying a set of network cell identifiers corresponding to the positioning configuration group; receiving a network cell identifier corresponding to the second network cell; and determining the second network cell is in the positioning configuration group based on the set of network cell identifiers including the network cell identifier corresponding to the second network cell.

Example 14 is the computer-implemented method of Example 13 that may optionally include receiving the network cell identifier in a broadcast message.

Example 15 is the computer-implemented method of Example 13 that may optionally include receiving the network cell identifier in in a unicast message.

Example 16 is the computer-implemented method of Example 1 that may optionally include determining a reference signal received power (RSRP) value in the second network cell; and comparing the RSRP value to a threshold to determine the second network cell is in the positioning configuration group.

Example 17 is the computer-implemented method of Example 1 that may optionally include releasing from a connected state to the idle state; and transmitting, in the idle state, a positioning sounding reference signal (SRSp).

Example 18 is the computer-implemented method of Example 17 that may optionally include that the idle state comprises a radio resource control (RRC) IDLE state.

Example 19 is the computer-implemented method of Example 1 that may optionally include that a portion of the positioning configuration for the first network cell is shared by each network cell in the positioning configuration group.

Example 20 is the computer-implemented method of Example 19 that may optionally include that the portion of the positioning configuration for the first network cell that is shared by each network cell in the positioning configuration group is indicated when the positioning configuration is obtained.

Example 21 is the computer-implemented method of Example 19 that may optionally include that the portion of the positioning configuration for the first network cell is shared by each network cell in the positioning configuration group comprises a sounding reference signal (SRS) parameter.

Example 22 is a user equipment (UE) comprising one or more processors configured to perform the computer-implemented method of any of Examples 1 to 21.

Example 23 is a non-transitory machine-readable medium having executable instructions to cause one or more processing units to perform the computer-implemented method of any of Examples 1 to 21.

Example 24 is a computer-implemented method, comprising providing a positioning configuration to a UE in a first network cell that is included in a positioning configuration group; releasing the UE from a connected state to an inactive or idle state in the first network cell; and enabling the UE, in the inactive or idle state, to utilize at least a portion of the positioning configuration obtained in the first network cell for positioning in a second network cell based on inclusion of the first and second network cells in the positioning configuration group.

Example 25 is the computer-implemented method of Example 24 that may optionally include utilizing a physical random access channel (PRACH) procedure to update the TA configuration of the UE for the second network cell.

Example 26 is the computer-implemented method of Example 25 that may optionally include utilizing the PRACH procedure to update the TA configuration in response to a determination the TA configuration is invalid based on a reference signal received power (RSRP) value in the second network cell being outside of a change threshold with respect to a stored downlink pathloss reference RSRP value.

Example 27 is the computer-implemented method of Example 26 that may optionally include that the change threshold is different for each network cell in the positioning configuration group.

Example 28 is the computer-implemented method of Example 27 that may optionally include that the change threshold is the same for each network cell in the positioning configuration group.

Example 29 is the computer-implemented method of Example 26 that may optionally include utilizing the PRACH procedure to update a path loss reference for the second network cell.

Example 30 is the computer-implemented method of Example 24 that may optionally include that the positioning configuration includes a positioning sounding reference signal (SRSp) configuration and a timing advance (TA) configuration.

Example 31 is the computer-implemented method of Example 24 that may optionally include that the positioning configuration includes a positioning sounding reference signal (SRSp) configuration.

Example 32 is the computer-implemented method of Example 24 that may optionally include releasing the UE from the connected state to the inactive state in the first network cell; and determining, with the UE in the inactive state, the second network cell is in the positioning configuration group based on a core network cell identifier.

Example 33 is the computer-implemented method of Example 32 that may optionally include that the core network cell identifier comprises a radio network temporary identifier (RNTI).

Example 34 is the computer-implemented method of Example 24 that may optionally include releasing the UE from the connected state to the idle state in the first network cell; and determining, with the UE in the idle state, the second network cell is in the positioning configuration group based on a base station cell identifier.

Example 35 is the computer-implemented method of Example 34 that may optionally include that the base station cell identifier comprises a temporary mobile subscriber identity (TMSI).

Example 36 is the computer-implemented method of Example 24 that may optionally include communicating a network cell identifier in a broadcast message, wherein the network cell identifier corresponds to a particular positioning configuration group.

Example 37 is the computer-implemented method of Example 24 that may optionally include communicating the network cell identifier in in a unicast message, wherein the network cell identifier corresponds to a particular positioning configuration group.

Example 38 is the computer-implemented method of Example 24 that may optionally include determining a reference signal received power (RSRP) value in the second network cell; and comparing the RSRP value to a threshold to determine the second network cell is in the positioning configuration group.

Example 39 is the computer-implemented method of Example 24 that may optionally include releasing the UE from a connected state to the idle state; and causing the UE, in the idle state, to transmit a positioning sounding reference signal (SRSp).

Example 40 is the computer-implemented method of Example 39 that may optionally include that the idle state comprises a radio resource control (RRC) IDLE state.

Example 41 is the computer-implemented method of Example 24 that may optionally include that a portion of the positioning configuration for the first network cell is shared by each network cell in the positioning configuration group.

Example 42 is the computer-implemented method of Example 41 that may optionally include that the portion of the positioning configuration for the first network cell that is shared by each network cell in the positioning configuration group is indicated in the positioning configuration.

Example 43 is the computer-implemented method of Example 41 that may optionally include that the portion of the positioning configuration for the first network cell is shared by each network cell in the positioning configuration group comprises a sounding reference signal (SRS) parameter.

Example 44 is a base station (BS) comprising one or more processors configured to perform the computer-implemented method of any of Examples 24 to 43.

Example 45 is a non-transitory machine-readable medium having executable instructions to cause one or more processing units to perform the computer-implemented method of any of Examples 24 to 43.

Example 46 is a computer-implemented method, comprising releasing from a connected state to an inactive or idle state at a user equipment (UE); determining a current positioning configuration is invalid; and obtaining, at the UE, an updated positioning configuration in the inactive or idle state.

Example 47 is the computer-implemented method of Example 46 that may optionally include obtaining the updated positioning configuration in the inactive state from a base station.

Example 48 is the computer-implemented method of Example 47 that may optionally include requesting, in the inactive state, the updated positioning configuration from the base station via a radio resource control (RRC) ResumeRequest network message.

Example 49 is the computer-implemented method of Example 47 that may optionally include obtaining the updated positioning configuration in an RRC Release with Suspend Configuration network message.

Example 50 is the computer-implemented method of Example 46 that may optionally include obtaining the updated positioning configuration in the idle state from a 5G core network.

Example 51 is the computer-implemented method of Example 50 that may optionally include requesting, in the idle state, the updated positioning configuration from the 5G core network via an RRC SetupRequest.

Example 52 is the computer-implemented method of Example 50 that may optionally include obtaining the updated positioning configuration in an RRC Release network message.

Example 53 is the computer-implemented method of Example 46 that may optionally include obtaining the updated positioning configuration with a random access channel (RACH) procedure.

Example 54 is the computer-implemented method of Example 53 that may optionally include that the RACH procedure comprises a two-step RACH procedure.

Example 55 is the computer-implemented method of Example 54 that may optionally include that the updated positioning configuration is received in a success random access response network message.

Example 56 is the computer-implemented method of Example 53 that may optionally include that the RACH procedure comprises a four-step RACH procedure.

Example 57 is the computer-implemented method of Example 56 that may optionally include that the updated positioning configuration is received in a radio resource control (RRC) release network message.

Example 58 is the computer-implemented method of Example 46 that may optionally include that the updated positioning configuration includes one or more of a timing advance (TA) parameter and a positioning sounding reference signal (SRSp) configuration.

Example 59 is the computer-implemented method of Example 46 that may optionally include utilizing, in the inactive or idle state, at least a portion of the updated positioning configuration for a positioning procedure to localize the UE based on communication of one or more network messages between the UE and at least one base station.

Example 60 is the computer-implemented method of Example 59 that may optionally include that the positioning procedure includes transmitting a positioning sounding reference signal (SRSp) based on receipt of an activation indication.

Example 61 is the computer-implemented method of Example 60 that may optionally include that the updated positioning configuration is obtained in response to the activation indication.

Example 62 is the computer-implemented method of Example 60 that may optionally include that the updated positioning configuration is obtained from the activation indication.

Example 63 is the computer-implemented method of Example 60 that may optionally include that the activation indication includes a positioning configuration indicator and the computer-implemented method further includes determining the current positioning configuration is invalid based on the positioning configuration indicator failing to correspond to the current positioning configuration; and obtaining the updated positioning configuration in response to determining the current positioning configuration is invalid based on the positioning configuration indicator failing to correspond to the current positioning configuration, wherein the updated positioning configuration corresponds to the positioning configuration indicator.

Example 64 is the computer-implemented method of Example 60 that may optionally include that the activation indication is received in one or more of a paging network messages, a system information block (SIB) network message, a radio resource control (RRC) Release network message, and a SRSp Configuration network message.

Example 65 is the computer-implemented method of Example 64 that may optionally include that the activation indication is included in one or more of a CellAccessRelatedInfo information element (IE), a Tracking Area IE, a radio access network (RAN) Area Code IE, a SRSp validity IE, an IntraFreqNeighborList IE, a SystemInformationAreaID IE, or an SRSpAreaID IE of the SIB network message.

Example 66 is the computer-implemented method of Example 64 that may optionally include that the activation indication is included in one or more of a payload of a paging physical downlink shared channel (PDSCH) network message.

Example 67 is the computer-implemented method of Example 64 that may optionally include that the activation indication is included in one or more of a payload of a physical downlink control channel (PDCCH) network message.

Example 68 is the computer-implemented method of Example 67 that may optionally include that the PDCCH network message comprises a paging PDCCH network message.

Example 69 is a user equipment (UE) comprising one or more processors configured to perform the computer-implemented method of any of Examples 46 to 68.

Example 70 is a non-transitory machine-readable medium having executable instructions to cause one or more processing units to perform the computer-implemented method of any of Examples 46 to 68.

Example 71 is a computer-implemented method, comprising releasing a user equipment (UE) from a connected state to an inactive or idle state; in response to a determination that a current positioning configuration is invalid, providing an updated positioning configuration to the UE in the inactive or idle state.

Example 72 is the computer-implemented method of Example 71 that may optionally include that a base station provides the updated positioning configuration to the UE in the inactive state.

Example 73 is the computer-implemented method of Example 72 that may optionally include receiving a request for the updated positioning configuration from the UE in the inactive state via a radio resource control (RRC) ResumeRequest network message.

Example 74 is the computer-implemented method of Example 72 that may optionally include providing the updated positioning configuration in an RRC Release with Suspend Configuration network message.

Example 75 is the computer-implemented method of Example 71 that may optionally include that a 5G core network provides the updated positioning configuration to the UE in the idle state.

Example 76 is the computer-implemented method of Example 75 that may optionally include providing the updated positioning configuration to the UE in the idle state via an RRC SetupRequest.

Example 77 is the computer-implemented method of Example 75 that may optionally include providing the updated positioning configuration in an RRC Release network message.

Example 78 is the computer-implemented method of Example 71 that may optionally include providing the updated positioning configuration via a random access channel (RACH) procedure.

Example 79 is the computer-implemented method of Example 78 that may optionally include that wherein the RACH procedure comprises a two-step RACH procedure.

Example 80 is the computer-implemented method of Example 79 that may optionally include that the updated positioning configuration is provided in a success random access response network message.

Example 81 is the computer-implemented method of Example 78 that may optionally include that the RACH procedure comprises a four-step RACH procedure.

Example 82 is the computer-implemented method of Example 81 that may optionally include that the updated positioning configuration is provided in a radio resource control (RRC) release network message.

Example 83 is the computer-implemented method of Example 71 that may optionally include that the updated positioning configuration includes one or more of a timing advance (TA) parameter and a positioning sounding reference signal (SRSp) configuration.

Example 84 is the computer-implemented method of Example 71 that may optionally include utilizing a positioning procedure to localize the UE based on communication of one or more network messages between the UE and at least one base station with the UE in the inactive or idle state and based on at least a portion of the updated positioning configuration

Example 85 is the computer-implemented method of Example 84 that may optionally include that the positioning procedure includes transmitting an activation indication to cause the UE to send a positioning sounding reference signal (SRSp).

Example 86 is the computer-implemented method of Example 85 that may optionally include that the activation indication causes the UE to obtain the updated positioning configuration.

Example 87 is the computer-implemented method of Example 85 that may optionally include that the updated positioning configuration is provided in the activation indication.

Example 88 is the computer-implemented method of Example 85 that may optionally include that the activation indication includes a positioning configuration indicator and the computer-implemented method further comprising transmitting the updated positioning configuration to the UE in response to the UE determining the current positioning configuration is invalid based on the positioning configuration indicator failing to correspond to the current positioning configuration, wherein the updated positioning configuration corresponds to the positioning configuration indicator.

Example 89 is the computer-implemented method of Example 85 that may optionally include that the activation indication is sent in one or more of a paging network messages, a system information block (SIB) network message, a radio resource control (RRC) Release network message, and a SRSp Configuration network message.

Example 90 is the computer-implemented method of Example 89 that may optionally include that the activation indication is included in one or more of a CellAccessRelatedInfo information element (IE), a Tracking Area IE, a radio access network (RAN) Area Code IE, a SRSp validity IE, an IntraFreqNeighborList IE, a SystemInformationAreaID IE, or an SRSpAreaID IE of the SIB network message.

Example 91 is the computer-implemented method of Example 89 that may optionally include that the activation indication is included in one or more of a payload of a paging physical downlink shared channel (PDSCH) network message.

Example 92 is the computer-implemented method of Example 89 that may optionally include that the activation indication is included in one or more of a payload of a physical downlink control channel (PDCCH) network message.

Example 93 is the computer-implemented method of Example 92 that may optionally include that the PDCCH network message comprises a paging PDCCH network message.

Example 94 is a base station (BS) comprising one or more processors configured to perform the computer-implemented method of any of Examples 71 to 93.

Example 95 is a non-transitory machine-readable medium having executable instructions to cause one or more processing units to perform the computer-implemented method of any of Examples 71 to 93.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

What is claimed is:

1. A computer-implemented method, comprising:
obtaining a positioning configuration in a first network cell that is included in a positioning configuration group;
releasing from a connected state to an inactive or idle state in the first network cell;
transitioning from the first network cell to a second network cell, wherein the second network cell is included in the positioning configuration group; and
utilizing, in the inactive or idle state, at least a portion of the positioning configuration obtained in the first network cell for positioning in the second network cell based on inclusion of the first and second network cells in the positioning configuration group.

2. The computer-implemented of claim 1, further comprising:
determining a timing advance (TA) configuration is invalid in the second network cell; and
utilizing a physical random access channel (PRACH) procedure to update the TA configuration for the second network cell.

3. The computer-implemented of claim 2, further comprising determining the TA configuration is invalid based on a reference signal received power (RSRP) value in the second network cell being outside of a change threshold with respect to a stored downlink pathloss reference RSRP value.

4. The computer-implemented of claim 3, wherein the change threshold is different for each network cell in the positioning configuration group.

5. The computer-implemented of claim 4, wherein the change threshold is the same for each network cell in the positioning configuration group.

6. The computer-implemented of claim 3, further comprising utilizing the PRACH procedure to update a path loss reference for the second network cell.

7. The computer-implemented of claim 1, wherein the positioning configuration includes a positioning sounding reference signal (SRSp) configuration and a timing advance (TA) configuration.

8. The computer-implemented of claim 1, wherein the positioning configuration includes a positioning sounding reference signal (SRSp) configuration.

9. The computer-implemented of claim 1, further comprising:
releasing from a connected state to the idle state; and
transmitting, in the idle state, a positioning sounding reference signal (SRSp).

10. The computer-implemented of claim 9, wherein the idle state comprises a radio resource control (RRC) IDLE state.

11. The computer-implemented of claim 1, wherein a portion of the positioning configuration for the first network cell is shared by each network cell in the positioning configuration group.

12. The computer-implemented of claim 11, wherein the portion of the positioning configuration for the first network cell that is shared by each network cell in the positioning configuration group is indicated when the positioning configuration is obtained.

13. The computer-implemented of claim 11, wherein the portion of the positioning configuration for the first network cell is shared by each network cell in the positioning configuration group comprises a sounding reference signal (SRS) parameter.

14. A user equipment (UE) comprising one or more processors configured to perform operations comprising:
obtaining a positioning configuration in a first network cell that is included in a positioning configuration group;
releasing from a connected state to an inactive or idle state in the first network cell;
transitioning from the first network cell to a second network cell, wherein the second network cell is included in the positioning configuration group; and
utilizing, in the inactive or idle state, at least a portion of the positioning configuration obtained in the first network cell for positioning in the second network cell based on inclusion of the first and second network cells in the positioning configuration group.

15. The UE of claim 14, wherein the one or more processors are further configured to perform operations comprising:
determining a timing advance (TA) configuration is invalid in the second network cell; and
utilizing a physical random access channel (PRACH) procedure to update the TA configuration for the second network cell.

16. The computer-implemented of claim 14, wherein a portion of the positioning configuration for the first network cell is shared by each network cell in the positioning configuration group.

17. The UE of claim 16, wherein the portion of the positioning configuration for the first network cell that is shared by each network cell in the positioning configuration group is indicated when the positioning configuration is obtained.

18. A non-transitory machine-readable medium having executable instructions to cause one or more processing units to perform a method, the method comprising:
obtaining a positioning configuration in a first network cell that is included in a positioning configuration group;
releasing from a connected state to an inactive or idle state in the first network cell;
transitioning from the first network cell to a second network cell, wherein the second network cell is included in the positioning configuration group; and
utilizing, in the inactive or idle state, at least a portion of the positioning configuration obtained in the first network cell for positioning in the second network cell based on inclusion of the first and second network cells in the positioning configuration group.

19. The non-transitory machine-readable medium of claim 18, the non-transitory machine-readable medium having instructions to cause one or more processing units to perform the method further comprising:
determining a timing advance (TA) configuration is invalid in the second network cell; and
utilizing a physical random access channel (PRACH) procedure to update the TA configuration for the second network cell.

20. The non-transitory machine-readable medium of claim 18, wherein a portion of the positioning configuration for the first network cell is shared by each network cell in the positioning configuration group.
